(19) United States
(12) Patent Application Publication
(10) Pub. No.: US 2010/0318957 A1
(43) Pub. Date: Dec. 16, 2010

(54) SYSTEM, METHOD, AND APPARATUS FOR EXTENSIBLE BUSINESS TRANSFORMATION USING A COMPONENT-BASED BUSINESS MODEL

(75) Inventors: Rama K. Akkiraju, Yorktown Heights, NY (US); Valeria Becker, Buenos Aires (AR); Rong Zeng Cao, Beijing (CN); Juan M. Cappi, Buenos Aires (AR); Wei Ding, Beijing (CN); Richard T. Goodwin, Dobbs Ferry, NY (US); Shun Jiang, Beijing (CN); Juhnyoung Lee, Yorktown Heights, NY (US); Kelly A. Lyman, Greenbrae, CA (US); Rakesh Mohan, Cortlandt Manor, NY (US); Pablo Pesce, Buenos Aires (AR); Jorge Sanz, Carmel, CA (US); Ignacio G. Terrizzano, San Jose, CA (US); Chun Hua Tian, Beijing (CN); John Vergo, Yorktown Heights, NY (US)

Correspondence Address: WILSON HAM & HOLMAN/ARC, 175 S. Main St. Suite 850, Salt Lake City, UT, 84111, US

(73) Assignee: International Business Machines Corporation, Armonk, NY (US)

(21) Appl. No.: 12/485,703

(22) Filed: Jun. 16, 2009

(51) Int. Cl. G06F 9/44

(52) U.S. Cl. 717/102

(57) ABSTRACT

A computer-implemented method for operating a business including operations to receive an enterprise model, define at least one new association between a first and a second business element in the enterprise model, federate a business analysis tool, and determine a business-related impact of the new association on other business elements in the enterprise model. The enterprise model is received at a model server and includes two or more business elements and a map of business components. The collection of business elements indicates associations between one or more business elements. The business analysis tools can filter the enterprise model and are federated by incorporating a business element generated from the business analysis tool into the enterprise model. The business-related impact is determined by using the business analysis tool.

### BACKGROUND

Business analysts use business modeling tools to visualize a representation of components of a business and relationships between components of the business. By providing a visual model of these components and relationships, the business modeling tools help analysts make decisions to improve the performance of the business.

The business modeling tools use a set of pre-defined business elements that model various types of business components. A particular pre-defined set of business elements and their relationships may provide an accurate representation of a particular component or set of components and relationships in the business, and may thus be used as elements in the modeling tool to represent the business. Often, however, due to the huge variety of businesses and viewpoints of analysts, the business modeling tool does not include a pre-defined business element or relationship that models a portion of a business in a way that satisfies the analyst.

As a result of this deficiency, analysts are forced by current business modeling tools to choose between an inaccurate or incomplete model and difficult, expensive custom coding. In many cases, the business model produced by the pre-defined components does not provide a sufficient level of accuracy in modeling the business. In these circumstances, analysts must choose between abandoning the model, and modifying the code of the software that operates the business model to meet their needs. Such modification is often not possible, due to the lack of access to proprietary code or due to the expense associated with customizing the software. Additionally, even if the code can be modified, updates to the software by the producer of the business tool will not incorporate the customizations, and the analyst must make the modifications again to the updated software in order to run the updated software.

This difficulty has resulted in the creation of external applications that operate using the business modeling tool with elements customized for a particular client or type of business. The external applications are useful, but create their own set of requirements and dependencies that often rule out their use by a particular business enterprise that does not fit the profile for which they were designed.

### SUMMARY

Embodiments of a computer-implemented method for transforming a business are described. In one embodiment, the computer-implemented method includes operations to receive an enterprise model, federate one or more business analysis tools, and determine a business-related impact on other business elements in the enterprise model. The enterprise model is received at a model server and includes two or more business elements, a plurality of maps of business components, and associations between one or more business elements. The business analysis tools can filter the enterprise model and are federated by incorporating one or more business elements generated from the business analysis tool into the enterprise model. The business-related impact is determined by using a business analysis tool. Other embodiments of the computer-implemented method are also described.

Embodiments of a computer program product for analyzing one or more enterprise models in a networked environment are also described. In one embodiment, the computer program product includes a computer useable storage medium to store a computer readable program. The computer readable program, when executed on a computer, causes the computer to perform operations including receiving a plurality of maps of business components for each enterprise model in the networked environment, receiving edits to the enterprise model and the respective map of business components, determining an impact of the edits on existing business elements in the enterprise model and the respective map of business components, and amending the enterprise model to incorporate the edits and the determined impact on existing business elements from the edits. The edits are received from a collaboration of a plurality of users of the networked environment. Determining the impact of the edits includes disseminating the edits through a federation of business insight analyses tools configured to filter the enterprise model and the respective map of business components. Amending the enterprise model includes amending the respective map of business components. Other embodiments of the computer program product method are also described.

Embodiments of a system are also described. In one embodiment, the system is a system for analyzing one or more enterprise models. In one embodiment, the system includes a business element database, a model platform, and an external application. The business element database is configured to store two or more business elements. Each business element describes an element of a business enterprise. The model platform communicates with the business element database and operates a modeling application. The modeling application includes an enterprise model receiver to receive an enterprise model, an association manager, an external application manager, a business map generator, and an insight analyzer. The enterprise model includes two or more business elements and one or more maps of business components. The collection of business elements indicates associations between any pair of business elements. The association manager defines at least one new association between a first business element and a second business element from the enterprise model. The external application manager federates one or more external applications with the modeling application. Federation of an external application with the modeling application includes incorporating a business element generated from an analysis tool of the external application into the modeling application. The business map generator generates an amended map of business components and an amended enterprise model in response to the at least one new association and the federation of one or more external applications. The insight analyzer determines a business-related impact of the at least one new association on one or more other business elements in the enterprise model by using one or more of the business elements generated from the one or more external applications. The external application includes one or more business analysis tools configured to filter an enterprise model. Other embodiments of the system are also described.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a schematic diagram of one embodiment of a system for extending and federating external business analysis tools with a modeling application.

FIG. 2 depicts a schematic diagram of one embodiment of the modeling application of FIG. 1.

FIG. 3 depicts a schematic diagram of another embodiment of a system for extending and federating external business analysis tools with a modeling application.

FIG. 4 is a flowchart diagram depicting one embodiment of a method for federating external business elements with a modeling application.

FIG. 5 is a flowchart diagram depicting one embodiment of a method for extending business elements for a modeling application.

FIG. 6 is a flowchart diagram depicting one embodiment of a method for federating external carbon emissions analysis business elements with a modeling application.

Throughout the description, similar reference numbers may be used to identify similar elements.

### DETAILED DESCRIPTION

In the following description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

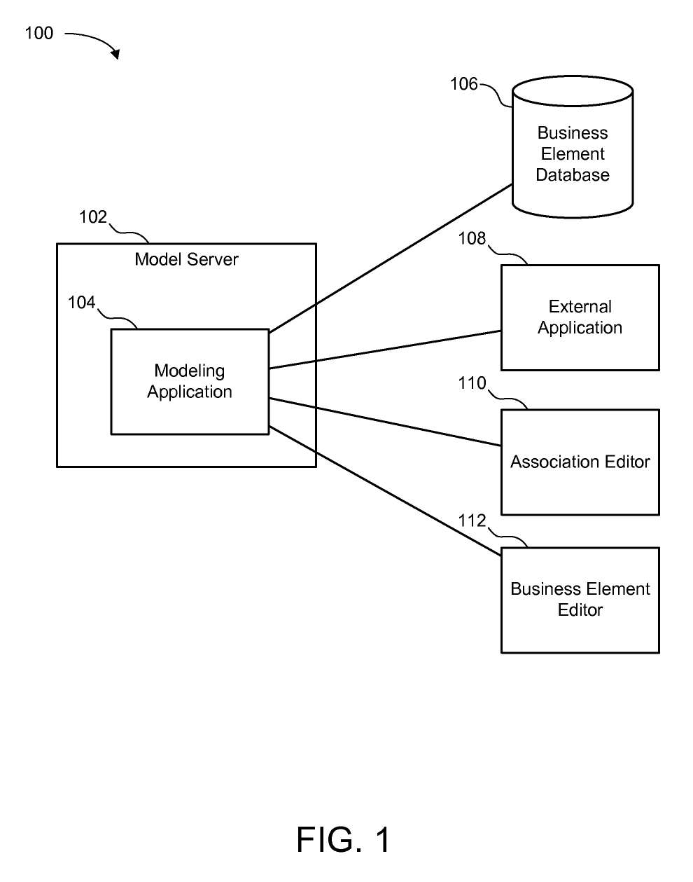

FIG. 1 depicts a schematic diagram of one embodiment of a system 100 for extending and federating external business analysis tools with a modeling application 104. The system 100 includes a model server 102, a modeling application 104, a business element database 106, an external application 108, an association editor 110, and a business element editor 112. The system 100 facilitates federation of components from the external application 108 with the modeling application 104. The system 100 also provides editors to modify business elements and associations between business elements.

The model server 102, in one embodiment, is a computer system that provides a platform for operation of the modeling application 104. The model server 102 may be a discrete computer system, a collection of networked computers, or a portion of a computer, such as a virtualized computer system. The model server 102 may be any type of computer system capable of operating the modeling application 104.

In one embodiment, the modeling application 104 operates on the model server 102 to model a business enterprise. The model generated by the modeling application 104 represents a business decomposition method that allows analysts to better understand the operation of the business enterprise and to choose business transformation opportunities to improve the business enterprise. In some embodiments, the modeling application is used to analyze the alignment of enterprise strategy with the capabilities and investments of the business enterprise, identify redundant or overlapping business capabilities, analyze sourcing options for the different components (buy or build), prioritize transformation options, and determine a unified roadmap after mergers or acquisitions.

In some embodiments, the model generated by the modeling application 104 displays the business enterprise as a collection of related business components that describe various functions of the business enterprise. In certain embodiments, the business enterprise includes business elements having various analysis inputs and outputs that allow the model to compute the impact of these elements on the overall business enterprise. Examples of business elements include applications, (business) solutions, organizations, metrics, and processes.

The modeling application 104 generates a map of business components and an enterprise model based on the business elements included in the model and associations defined between those business elements. In some embodiments, an amended map of business components and an amended enterprise model are generated in response to changes to business elements and/or associations between business elements in the model. In one embodiment, an amended map of business components and an amended enterprise model are generated in response to federation of a business analysis tool from an external application 108 with the modeling application 104.

In certain embodiments, the modeling application 104 filters the map of business components and generates possible business transformation opportunities in response to changes in the business elements and the associations between business elements in the model. The modeling application 104 identifies an impact on the business for possible business transformation opportunities based on the enterprise model. A federated business analysis tool from an external application 108 may be used in determining the impact on the business for possible business transformation opportunities. The modeling application 104 determines a preferred business transformation opportunity that should be implemented by the business based on the analysis performed upon the amended enterprise model and amended map.

The business element database 106, in one embodiment, is in communication with the modeling application and stores a plurality of business elements that describe various functions that may be used in a business enterprise. In the illustrated embodiment, the business element database 106 is separate from the model server 102. For example, the business element database 106 may reside on a separate database server in communication with the model server 102 over a network connection (not shown). In alternative embodiment, the business element database 106 may operate on the model server 102.

In one embodiment, each business element in the business element database 106 may include analysis inputs and/or outputs that describe the needs and generated work of the particular function. The business element database includes a set of generic, predefined business elements that may be included in a particular model to represent a particular business enterprise. In some embodiments, the business elements in the business element database 106 include one or more business elements customized for a particular business.

The modeling application 104, in certain embodiments, describes associations among a group of business elements selected from the business element database 106 to generate an enterprise model and a map of business components indicating the associations. This map provides an accessible view to the business analyst that describes the business enterprise using discreet business components. In some embodiments, the map is displayed on a single page.

In one embodiment, the external application 108 generates analysis for a business enterprise. In some embodiments, the external application 108 operates using elements of the modeling application 104 to model a business enterprise. The external application 108 may be customized for a particular business, type of business, or industry group.

The external application 108, in some embodiments, includes one or more business analysis tools that are not defined by the modeling application 104 as business elements. Examples of business analysis tools in an external application 108 include, but are not limited to, tools that model resources, projects, and/or business functions. Since these external business analysis tools may be useful to businesses outside of the profile for which the external application was developed 108 the modeling application 104 federates these external business analysis tools and makes them available to businesses using the modeling application 104 as federated business elements.

In one embodiment, a federated business element from an external application 108 is added to the business element database 106. In an alternative embodiment, the federated business element from the external application 108 is federated using a link to the federated business element in the external application 108. The federated business element is made available to a business analyst modeling a business enterprise using the modeling application 104.

In some embodiments, the modeling application 104 monitors the external application 108 to determine changes to the federated business element. Modification to a federated business element may result in modification to the enterprise model and/or the business element made available to analysts using the modeling application 104. In some embodiments, modification to a federated business element in an external application 108 results in the addition of a new business element to the business element database 106.

Federation of the business element from an external application 108, in some embodiments, includes determining the types of association available to the business element. The association editor 110, in one embodiment, communicates with the modeling application 104 and determines the types of association available to a federated business element. In some embodiments, the association editor 110 receives input from a user as a part of the Federation process to determine appropriate association types. In an alternative embodiment, the association editor 110 analyzes the federated business element to determine association types. For example, the association editor at 110 may use machine learning techniques to determine appropriate association types for the federated business element.

In certain embodiments, the association editor 110 defines associations between business elements in the model of the business enterprise. For example, the model of a business enterprise may include two business elements, and the association editor 110 may indicate a relationship between the two business elements. In one embodiment, the association editor 110 is capable of editing, creating, or deleting an association between any two business elements in a model, whether predefined or originating from an external application. The association editor 110, in the illustrated embodiment, is external to the modeling application 104. In an alternative embodiment, the association editor 110 is a component of the modeling application 104. In some embodiments, system 100 includes a plurality of association editors 110 including at least one association editor 110 external to the modeling application 104 and at least one association editor 110 internal to the modeling application 104.

In certain embodiments, the business element editor 112 is in communication with the modeling application 104 and edits business elements in the business element database 106. The business element editor 112 provides an interface allowing a business analyst to make changes to a business element so that the modified business element more closely models a component of the business enterprise. For example, an analyst may edit a generic business element template from the business element database 106 to create a custom business element that better models in aspect of the business enterprise. This custom business element may then be stored in the business element database 106. In some embodiments, the business element editor 112 may edit a federated business element. In the illustrated embodiment, the business element editor 112 is external to the modeling application 104. In an alternative embodiment, the business element editor 112 is a component of the modeling application 104. In some embodiments, system 100 includes a plurality of business element editors 112 including at least one business element editor 112 external to the modeling application 104 and at least one business element editor 112 internal to the modeling application 104.

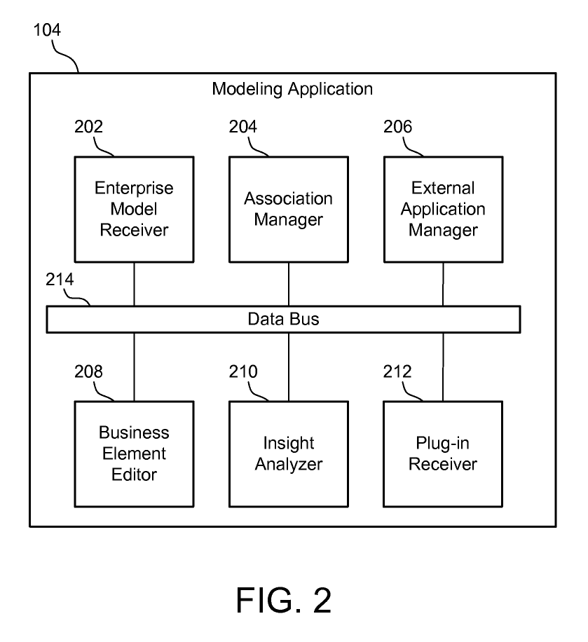

FIG. 2 depicts a schematic diagram of one embodiment of the modeling application 104 of FIG. 1. The modeling application 104 includes an enterprise model receiver 202, an association manager 204, an external application manager 206, a business element editor 208, an insight analyzer 210, a plug-in receiver 212, and a data bus 214. The modeling application 104 operates an enterprise model and determines business related impacts for business scenarios determined by configurations of business elements and relationships between the business elements.

In one embodiment, the enterprise model receiver 202 receives an enterprise model. The enterprise model includes the predefined business elements and two or more external business elements and the relationships between the business elements, whether predefined or external. The enterprise model receiver 202 may receive the enterprise model by any method of data communication. For example, the enterprise model receiver 202 may receive the enterprise model over the data bus 214 from a data storage device (not shown).

The association manager 204, in one embodiment, manages associations between business elements within the enterprise model. The association manager 204 communicates the associations to other elements of the modeling application 104 over the data bus 214. The association manager 204 may define how the output of one business element impacts another business element. For example, the association manager 204 may indicate that the output of a first business element is an input for a second business element, and that changes to parameters associated with the first business element may result in changes to parameters associated with the second business element. In one embodiment, the association manager 204 is capable of indicating associations between any two or more business elements.

In one embodiment, the external application manager 206 manages a relationship between the modeling application 104 and one or more external applications 108. The external application manager 206 manages definitions of federated external business elements in and monitors those external business elements for changes. The external application manager 206 communicates information relating to the external application 108 over the data bus 214.

The business element editor 208, in one embodiment, edits business elements. The business element editor 208 may include a collection of one or more specialized business element editors (not shown), each of the specialized business element editors configured to edit a particular type of business element. The collection of specialized business element editors may include a specialized business element editor that operates as part of the modeling application 104 and/or a specialized business element editor that operates external from the modeling application 104. In some embodiments, the business element editor 208 edits existing business elements and/or federated business elements to create new or modified business elements more suitable to the requirements of the business analyst. The business element editor 208 creates new elements in some embodiments. The business element editor 208 may respond to an input from a business analyst to edit business elements. The business element editor 208 may automatically determine edits for a business element in response to machine learning techniques. The business element editor 208 communicates changes to business elements over the data bus 214. For example, the business element database 106 may be in communication with the modeling application 104 over the data bus 214, and the business element editor 208 may communicate changes to business elements to the business element database 106 over the data bus 214.

The insight analyzer 210, in one embodiment, analyzes the enterprise model to determine impacts and business transformation opportunities. The insight analyzer 210 receives the enterprise model over the data bus 214 from the enterprise model receiver 202. Associations between business elements are received over the data bus 214 from the association manager 204 by the insight analyzer 210. The insight analyzer 210 may also receive information about federated business elements from the external application manager 206. The insight analyzer 210 determines a business-related impact of associations between business elements in the enterprise model. In certain embodiments, the insight analyzer 210 uses a federated business element from an external application 108 to determine business related impacts of associations between business elements.

The insight analyzer 210, in one embodiment, performs an analysis using the federated business element, including, but not limited to, daisy-chain analysis, heat map analysis, shortfall assessment, solution discovery analysis, business case analysis, project prioritization, and project influence analysis. In some embodiments, the insight analyzer 210 performs quantitative and qualitative analyses using the federated business element. The insight analyzer 210 may also perform cash flow analysis, what-if analysis, sensitivity analysis, interactive visualization, queries, and green transformation analysis. The insight analyzer 210 filters the model of the business enterprise to determine business transformation opportunities using the federated business element.

In some embodiments, the insight analyzer 210 may use a federated business element to perform a heat map analysis that determines a carbon footprint of business activities for the business enterprise. The insight analyzer 210 may use a federated business element to combine a cash flow analysis and a carbon flow analysis to determine a trade-off analysis and business optimization in conjunction with a carbon emission credit regime.

The plug-in receiver 212, in one embodiment, communicates with other elements of the modeling application 104 over the data bus 214. The plug-in receiver 212 receives information about an external application 108 that conforms to a plug-in definition. Using the plug-in definition, creators of an external application 108 can design the external application 108 to provide business elements for federation to the plug-in receiver 212. For example, the modeling application 104 may have a particular plug-in definition, and the creators of an external application 108 may design analysis tools that conform into the particular plug-in definition. The modeling application 104 may then receive the analysis tools through the plug-in receiver 212 to be used as business elements in the modeling application 104. The plug-in receiver 212 represents a streamlined, efficient manner of federating analysis tools from external applications 108.

The data bus 214 provides a communication pathway within the modeling application 104 for various elements of the modeling application 104. The data bus 214 may be any type of data communication system, including, but not limited to, a hardware bus, a wired connection, a network, a mesh system, and a wireless communication system. In some embodiments, the data bus 214 may include a combination of types of data communication system.

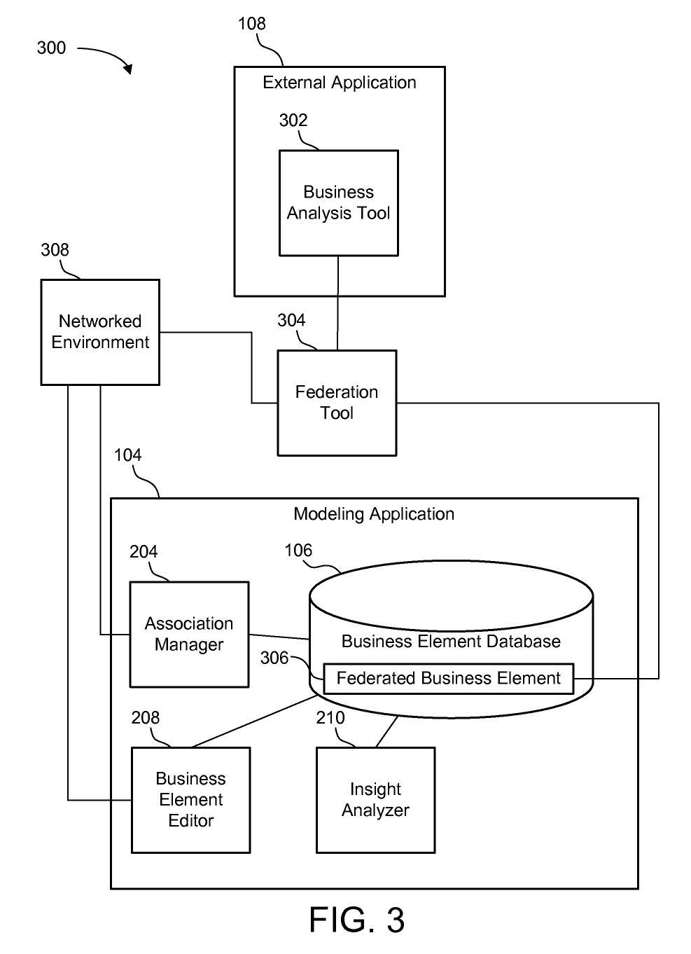

FIG. 3 depicts a schematic diagram of another embodiment of a system 300 for extending and federating external business analysis tools 302 with a modeling application 104. The system 300 includes an external application 108, a federation tool 304, and a modeling application 104. The system 300 facilitates federation of components from the external application 108 with the modeling application 104.

The external application 108, in one embodiment, includes one or more business analysis tools 302. The business analysis tool 302 includes analysis inputs and/or outputs and is used to model a particular aspect or function of a business enterprise. In some embodiments, the external application 108 operates using functions and/or elements of the modeling application 104. For example, the external application 108 may be an extension of the modeling application 104.

In some embodiments, a plurality of external applications 108 are associated with the modeling application 104 by means of the inclusion of external business elements and added relationships. The modeling application 104 may act as a hub at the center of the plurality of external applications 108 which are federated with the modeling application 104. For example, en enterprise model and corresponding map of business components operating at the modeling application 104 may include federated business elements 306 from two or more external applications 108. In this example, the map of business components is a hub at the center of the plurality of external applications 108 and is capable of accessing and using federated business elements 306 from multiple external applications 108.

In one embodiment, the federation tool 304 federates the business analysis tool 302 with the modeling application 104. The federation tool 304 is in communication with the external application 108 and receives the business analysis tool 302. The federation tool 304 determines analysis inputs and/or outputs for the business analysis tool 302 and, if required, configures the business analysis tool to a format acceptable to the modeling application 104. In some embodiments, the business analysis tool 300 to conforms to a plug-in specification and the federation tool 304 acts as a plug-in receiver 212. The federation tool 304 may monitor the business analysis tool 302 to determine changes to the business analysis tool 302 and communicate those changes to the modeling application 104.

The modeling application 104, in one embodiment, is in communication with the federation tool 304 and receives the business analysis tool 302 as a federated business element 306. In the illustrated embodiment, the federated business element 306 is stored in the business element database 106 by the modeling application 104 for use by the modeling application 104. In an alternative embodiment, the federation tool 304 provides a link between the business analysis tool 302 and the modeling application 104. The federated business element 306 is accessible to the association manager 204, the business element editor 208, and the insight analyzer 210 and may be used in an enterprise model in the modeling application 104.

In some embodiments, the system 300 operates in conjunction with a networked environment 308 that allows access to components of the system 300 by a plurality of users over the networked environment 308. The plurality of users may collaborate to provide inputs to the system 300 to manage federation and/or editing of business elements. For example, the plurality of users may have access to the federation tool 304 through the networked environment 308 to determine external applications 108 and business analysis tools 302 in the external applications 108 that should be federated with the modeling application 104. In another example, the plurality of users may have access to the association manager 204 and/or the business element editor 208 through the networked environment 308 to modify business elements and enterprise models. In some embodiments, changes made through the networked environment 308 by one or more users are available to other users of the networked environment 308. For example, a user in the networked environment 308 may edit a business element to model a particular function for a particular business. The modified business element is stored in the business element database 106 and made available to other users in the networked environment 308.

The networked environment is a social network in some embodiments. For example, the networked environment may include a social structure of individuals and organizations, e-mail communication, instant messaging communication, wiki-based collaboration, weblogs (blogs), video sharing, and collaborative tagging and subject indexing. The system 300 may also be accessible and controllable through an avatar-based virtual world, such as Second Life®, an avatar-based virtual world developed and owned by Linden Lab®.

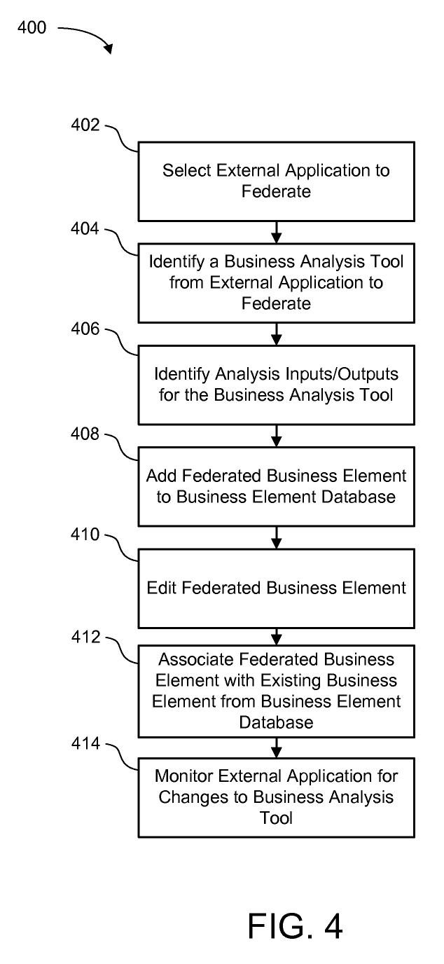

FIG. 4 is a flowchart diagram depicting one embodiment of a method for federating external business elements with a modeling application. The external application manager 206 selects 402 an external application 108 to federate. Selection 402 may take place automatically in response to detection of an external application 108. In an alternative embodiment, selection 402 may be in response to an input from a user.

The federation tool 304 identifies 404 a business analysis tool 302 from the external application 108 to federate with the modeling application 104. Identification 404 of the business analysis tool 302 may take place automatically in response to a scan of the external application 108 by the federation tool 304. In an alternative embodiment, identification 404 of the business analysis tool 302 may take place in response to an input from a user. For example, a user may identify 404 the business analysis tool 302 using an interface (not shown) that accesses the external application 108.

The federation tool 304 identifies 406 analysis inputs and/or outputs for the business analysis tool 302. The analysis inputs and/or outputs are used by the federation tool 304 to convert the business analysis tool 302 into a federated business element 306. Identification 406 of the analysis inputs and/or outputs may take place automatically or in response to an input by a user.

The federation tool 304 adds 408 the generated federated business element 306 to the business element database 106. In some embodiments, adding 408 the federated business element 306 may involve adding an entry to the business element database 106 including the description of the federated business element 306. In an alternative embodiment, adding 408 to federated business element 306 may involve adding a link to the business analysis tool 302 at the external application 108.

The business element editor 208 edits 410 the federated business element 306. Editing 410 may take place automatically, such as through a machine learning process designed to change the federated business element 306 to better model a business enterprise. Editing 410 may also take place in response to an input from a user. Editing 410 may include adding, deleting, and/or changing analysis inputs and/or outputs. Editing 410 may also include indicating and/or changing allowable association types for the federated business element 306.

The association manager 204 associates 412 the federated business element 306 with an existing business element from the business element database 106. The association 412 indicates a relationship between the federated business element 306 and the existing business element from the business element database 106 that models an aspect of the business enterprise. The existing business element may be any type of business element, including, but not limited to, another federated business element, a generic business element template, a business element created by modifying a generic business element template, or a newly created business element.

The federation tool 304 monitors 414 the external application 108 to detect changes to the business analysis tool 302. Changes to the business analysis tool 302 may result in the federation tool 304 modifying the federated business element 306. Changes to the business analysis tool 302 may result in federation tool 304 creating a new federated business element in the business element database 106.

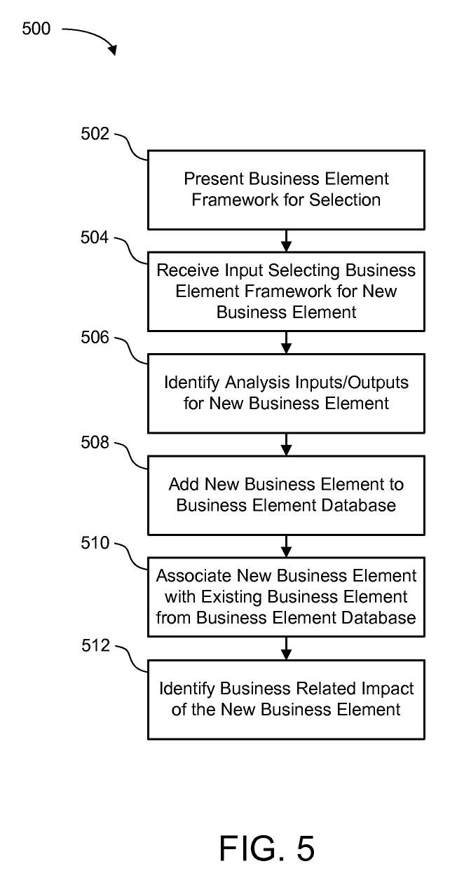

FIG. 5 is a flowchart diagram depicting one embodiment of a method 500 for extending business elements for a modeling application 104. The business element editor 208 presents 502 a business element framework for selection. The business element framework may be an existing business element which is to be extended by modifying an aspect of the existing business element to model an aspect of a business enterprise. For example, a particular business element editor 208 may present 502 a collection of generic business element templates which the user may browse.

The particular business element editor 208 receives 504 an input selecting a business element framework for use in creating a new business element. For example, the user may select a generic business element template to modify after browsing a collection of generic business element templates.

The particular business element editor 208 identifies 506 analysis inputs and/or outputs for a newly defined business element. The newly defined business element may be edited form of the business element framework with modified analysis inputs and/or outputs. The business element editor 208 adds 508 the newly defined business element to the business element database 106. The newly defined business element is made available to the modeling application 104 and may be used in an enterprise model.

The association manager 204 associates 510 the newly defined business element with an existing business element from the business element database 106. The association 510 indicates a relationship between the newly defined business element and the existing business element from the business element database 106 that models an aspect of the business enterprise. The existing business element may be any type of business element, including, but not limited to, another newly defined business element, a generic business element template, a business element created by modifying a generic business element template, or a federated business element.

The insight analyzer 210 identifies 512 a business related impact of the newly defined business element. For example, the insight analyzer 210 may generate a benchmark data-based heat map analysis using financial metrics. A newly defined business element may impact the heat map analysis, and the insight analyzer 210 generates a new heat map analysis and identifies 512 business related impacts of the newly defined business element.

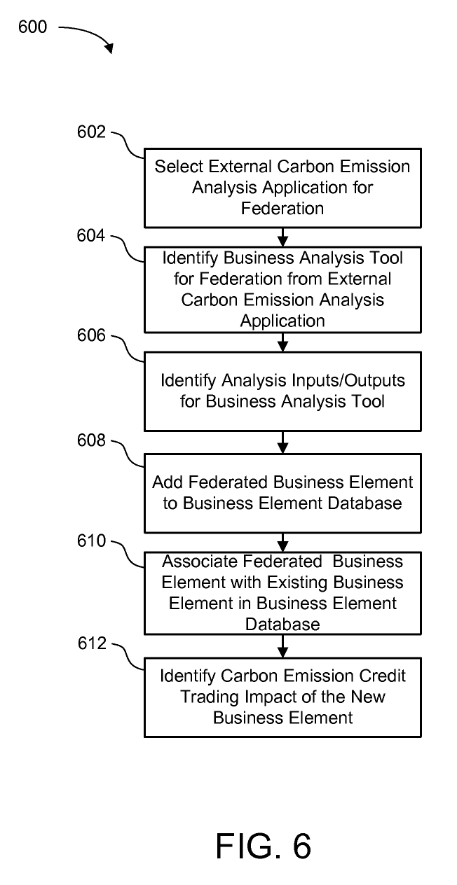

FIG. 6 is a flowchart diagram depicting one embodiment of a method 600 for federating external carbon emissions analysis business elements with a modeling application 104. The external application manager 206 selects a 602 an external carbon emission analysis application for federation. Selection 602 may take place automatically in response to detection of an external carbon emission analysis application or may be in response to an input from a user.

The federation tool 304 identifies 604 a business analysis tool 302 from the external carbon emissions analysis application to federate with the modeling application 104. Identification 604 of the business analysis tool 302 may take place automatically in response to a scan of the external carbon emission analysis application by the federation tool 304. In an alternative embodiment, identification 604 of the business analysis tool 302 may take place in response to an input from a user. For example, a user from a networked environment 308 may identify 404 the business analysis tool 302 using an interface for a wiki-based collaboration tool (not shown) that accesses the federation tool 304.

The federation tool 304 identifies 606 analysis inputs and/or outputs for the business analysis tool 302. The analysis inputs and/or outputs are used by the federation tool 304 to convert the business analysis tool 302 into a federated business element 306. Identification 606 of the analysis inputs and/or outputs may take place automatically or in response to an input by a user.

The federation tool 304 adds 608 the generated federated business element 306 to the business element database 106. In some embodiments, adding 608 the federated business element 306 may involve adding an entry to the business element database 106 including a description of the federated business element 306. In an alternative embodiment, adding 608 to federated business element 306 may involve adding a link to the business analysis tool 302 at the external carbon emissions analysis application. The federated business element 306 is made available to the modeling application 104 and may be used in an enterprise model.

The association manager 204 associates 610 the federated business element 306 with an existing business element from the business element database 106. The association 610 indicates a relationship between the federated business element 306 and the existing business element from the business element database 106 that models an aspect of the business enterprise. The existing business element may be any type of business element, including, but not limited to, another federated business element, a generic business element template, a business element created by modifying a generic business element template, or another federated business element.

The insight analyzer 210 identifies 612 a carbon emission credit trading impact of the federated business element 306. For example, the insight analyzer 210 may generate a benchmark data-based heat map analysis using financial metrics to determine a preferred configuration for the business enterprise to reduce carbon emissions in a cost-effective manner under a carbon emission credit trading program. A federated business element 306 from an external carbon emission analysis application may impact the heat map analysis, and the insight analyzer 210 generates a new heat map analysis and identifies 612 carbon emission credit trading impacts of the federated business element 306.

It should also be noted that at least some of the operations for the methods may be implemented using software instructions stored on a computer useable storage medium for execution by a computer. As an example, an embodiment of a computer program product for analyzing one or more enterprise models in a networked environment includes a computer useable storage medium to store a computer readable program that, when executed on a computer, causes the computer to perform operations, including receiving an enterprise model and a map of business components for each enterprise model in the networked environment, receiving edits to the enterprise model and the respective map of business components, determining an impact of the edits on existing business elements in the enterprise model and the respective map of business components, and amending the enterprise model to incorporate the edits and the determined impact on existing business elements from the edits . The edits are received from a collaboration of a plurality of users of the networked environment. Determining the impact of the edits includes disseminating the edits through a federation of business insight analyses tools configured to filter the enterprise model and the respective map of business components. Amending the enterprise model includes amending the respective map of business components and related business elements.

Embodiments of the invention can take the form of an entirely hardware embodiment, an entirely software embodiment, or an embodiment containing both hardware and software elements. In one embodiment, the invention is implemented in software, which includes but is not limited to firmware, resident software, microcode, etc.

Furthermore, embodiments of the invention can take the form of a computer program product accessible from a computer-usable or computer-readable storage medium providing program code for use by or in connection with a computer or any instruction execution system. For the purposes of this description, a computer-usable or computer readable storage medium can be any apparatus that can store the program for use by or in connection with the instruction execution system, apparatus, or device.

The computer-useable or computer-readable storage medium can be an electronic, magnetic, optical, electromagnetic, infrared, or semiconductor system (or apparatus or device), or a propagation medium. Examples of a computer-readable storage medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

An embodiment of a data processing system suitable for storing and/or executing program code includes at least one processor coupled directly or indirectly to memory elements through a system bus such as a data, address, and/or control bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Additionally, network adapters also may be coupled to the system to enable the data processing system to become coupled to other data processing systems or remote printers or storage devices through intervening private or public networks. Modems, cable modems, and Ethernet cards are just a few of the currently available types of network adapters.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A computer-implemented method for transforming a business, comprising:
receiving, at a common model server, an enterprise model including a plurality of business elements, a plurality of maps of business components and associations between one or more business elements;
federating one or more business analysis tools configured to filter the enterprise model on the model platform, wherein federating a business analysis tool includes incorporating a business element generated from the business analysis tool into the enterprise model; and
determining a business-related impact on one or more other business elements in the enterprise model by using one or more of the business analysis tools.

2. The computer-implemented method of claim 1, further comprising generating an amended map of business components and an amended enterprise model representing a transformed business operation in response to the federation of business analysis tools.

3. The computer-implemented method of claim 2, further comprising:
filtering the amended enterprise model and maps of business components using the federation of business insight analyses tools;
receiving a plurality of possible business transformation opportunities for the business;
identifying for each possible business transformation opportunity an impact on the business from the amended enterprise model, including the amended map of business components; and
determining from the possible business transformation opportunities using the identified impacts a business transformation opportunity to be implemented by the business.

4. The computer-implemented method of claim 2, further comprising:
filtering the amended enterprise model using the federation of business insight analyses tools, where the maps of business components is a hub of the federation of business analysis tools;
receiving a plurality of possible business transformation opportunities for the business;
identifying for each possible business transformation opportunity the impact on the business from the amended map of business components; and
determining from the possible business transformation opportunities using the identified impacts a business transformation opportunity to be implemented by the business.

5. The computer-implemented method of claim 1, wherein the business elements comprise at least one business element from the group consisting of:
applications;
business solutions;
organizations;
metrics; and
processes.

6. The computer-implemented method of claim 1, further comprising:
inserting a newly defined business element into the enterprise model, wherein the at least one new association is an association among the new business element and one or more business elements in the enterprise model.

7. The computer-implemented method of claim 6, wherein the newly defined business element comprises a business element from the group consisting of:
a resource;
a project; and
a business function.

8. The computer-implemented method of claim 1, wherein the federation of business analysis tools comprises at least one business insight analysis from the group consisting of:
daisy-chain analysis;
shortfall assessment;
solution discovery analysis;
business case analysis;
project prioritization; and
project influence analysis.

9. The computer-implemented method of claim 1, wherein the federation of business analysis tools includes a carbon emission analysis tool.

10. The computer-implemented method of claim 9, wherein the carbon emission analysis tool determines business transformation opportunities in response to a carbon emission credit trading regime.

11. The computer-implemented method of claim 1, wherein the defined at least one new association is from editing an existing association in the enterprise model.

12. A computer program product comprising a computer useable storage medium to store a computer readable program, wherein the computer readable program, when executed on a computer, causes the computer to perform operations for analyzing one or more enterprise models in a networked environment, the operations comprising:
receiving a plurality of maps of business components for each enterprise model in the networked environment;
receiving edits to the enterprise model and the respective map of business components from a collaboration of a plurality of users of the networked environment;
determining an impact of the edits on existing business elements in the enterprise model and the respective map of business components, wherein determining the impact comprises disseminating the edits through a federation of business insight analyses tools configured to filter the enterprise model and the respective map of business components; and
amending the enterprise model to incorporate the edits and the determined impact on existing business elements from the edits, wherein amending the enterprise model includes amending the respective map of business components.

13. The computer program product of claim 12, further comprising:
filtering the amended maps of business elements using the federation of business insight analyses tools;
receiving a plurality of possible business transformation opportunities for the business from the plurality of users of the networked environment;
identifying for each possible business transformation opportunity an impact on the business from the amended enterprise mode, the respective maps of business elements, and collaboration between the plurality of users; and
determining from the possible business transformation opportunities using the identified impacts a business transformation opportunity to be implemented by the business.

14. The computer program product of claim 12, wherein the networked environment is a social network.

15. The computer program product of claim 14, wherein the social network comprises an at least one collaboration mechanism from the group consisting of:
social structures of individuals and organizations;
emails;
instant messaging;
wikis;
blogs;
video sharing; and
collaborative tagging and subject indexing.

16. The computer program product of claim 14, wherein the social network comprises an avatar-based virtual world.

17. A system for analyzing one or more enterprise models comprising:
a business element database to store a plurality of business elements, each business element to describe an element of a business enterprise;
a model platform in communication with the business element database, the model platform to operate a modeling applications comprising:
an enterprise model receiver to receive an enterprise model including a plurality of business elements and a plurality of maps of business components, the plurality of business elements to indicate associations between two or more business elements;
an association manager to define at least one new association between a first business element and a second business element from the enterprise model;
an external application manager to federate an external application with the modeling application, wherein federating an external application with the modeling application includes incorporating a business element generated from an analysis tool of the external application into the modeling application;
a business map generators to generate an amended map of business components and an amended enterprise model in response to the at least one new association and the federation of the external application; and
an insight analyzer to determine a business-related impact of the at least one new association on one or more other business elements in the enterprise model by using one or more of the business elements generated from the one or more external applications; and
an external application comprising one or more business analysis tools configured to filter an enterprise model.

18. The system of claim 17, wherein the modeling application further comprises a business element editor to modify a business element in the business element database.

19. The system of claim 17, wherein the modeling application further comprises a business element editor to create a newly defined business element in the business element database.

20. The system of claim 17, wherein the modeling application further comprises a plug-in receivers to receive inputs from an external plug-in, the external plug-in to conform to a plug-in specification and to provide a business element from the external application to the modeling application.
